(19) United States
(12) Patent Application Publication
(10) Pub. No.: US 2024/0273514 A1
(43) Pub. Date: Aug. 15, 2024

(54) COMPUTER IMPLEMENTED TOKENIZATION SYSTEM - A METHOD TO TOKENIZE AND CAPTURE CONTENT QUALITY

(71) Applicant: Vybe LLC, McLean, VA (US)

(72) Inventor: Douglas L. POPOVICH, McLean, VA (US)

(73) Assignee: Vybe LLC, McLean, VA (US)

(21) Appl. No.: 18/109,371

(22) Filed: Feb. 14, 2023

(51) Int. Cl. G06Q 20/36; G06Q 20/06; G06Q 50/00

(52) U.S. Cl. CPC G06Q 20/36; G06Q 20/065; G06Q 50/01

(57) ABSTRACT

A computer-implemented tokenization system, comprising: one or more processors; one or more hardware-based memory devices storing executable instructions which, when executed by the one or more processors, cause the computer-implemented tokenization system to perform: Excavation for finding, collecting and quantifying content quality associated with creator account from multiple centralized creator websites and software applications; and Tokenization for converting content quality into a standard token that can be held, transferred and converted into other assets on a decentralized blockchain; and Dispersion for sending tokenized likes to creators' wallets.

### BACKGROUND

An estimated 4.48 billion people use social media. Each person has, on average, 8.4 social media accounts, and spends three hours a day using them. This means that over half of the world's population use over 37 billion social media accounts. Anyone who posts original content on these websites and software applications, for instance, comments, photos, and videos, is a creator. This content is frequently valuable, which is evidenced by the number of people who applaud this content with upvotes, thumbs up, hearts, retweets, followers, subscribers, and comments. Various photo sharing websites and software applications routinely generate over a billion likes per day.

A creator's content is valuable, but it's frequently spread across multiple centralized and disconnected websites and software applications. It's quantified differently on each website/application, and creators can't remove that value from these websites and software applications. They usually aren't paid for it and have a hard time monetizing the content posted on these websites and software applications. For instance, one photo sharing application, which made over $20 billion dollars in ad revenue in 2019, earned this without posting hardly any content of their own. They posted their creators' content instead, but didn't pay their creators any percentage or portion of this $20 billion dollars. They paid their creators, instead, with virtual likes and heart emojis. This is a common practice and the industry standard.

### SUMMARY

Creator sites like Reddit®, TikTok®, Instagram®, Facebook® and YouTube® make billions of dollars from their creators' content, but usually don't pay their creators money for this. They pay them, instead, in various forms of engagement, such as digital emojis, like thumbs-ups, upvotes, hearts and happy faces. These forms of digital engagement are used to measure content quality on websites and software applications and are collectively called “likes” here. Creators don't control these likes or the value they represent, and they are isolated in different forms on different sites.

The creator economy is growing, and creators need better ways to own, control, and monetize their valuable content. They need, specifically, a way to quantify, aggregate, and capture the value of their content across all their sites, and the ability to transfer this value to private wallets they control, where they can hold or convert it to other assets. There is nothing in the art that currently does this with blockchain and tokenization technology.

The problem of not being able to tokenize content and move it to a blockchain wallet has not been solved before. The present invention claims a computer implemented tokenization system which aggregates, tokenizes, and transfers likes off centralized websites and onto a decentralized blockchain. The computer implemented tokenization system makes it possible to convert content quality into a token that can be used on a blockchain. By doing this, the computer implemented tokenization system captures a creator's value and puts it in their wallet, which makes it possible for them to better control their content and convert it to other assets.

In accordance with one embodiment, the present invention is a method to find, aggregate and excavate content quality from multiple centralized websites and software applications; a method to tokenize that content quality into a standard token that can be held, transferred, and converted into other tokens on a decentralized blockchain; and a method to disperse that tokenized value to creators' wallets.

In accordance with one embodiment, the present invention is a program of machine-readable instructions, tangibly embodied on an information bearing medium, that excavates, tokenizes and disperses value. The actions of the program include, specifically, to find, aggregate and excavate content quality from multiple centralized creator websites and software applications; to tokenize that content quality into a standard token that can be held, transferred, and converted into other tokens on a decentralized blockchain; and to disperse that tokenized value to creators' wallets.

In accordance with another embodiment, the present invention is one or more hardware-based non-transitory computer-readable memory devices having instructions which, when executed by one or more processors, cause the computer implemented tokenization system to perform Excavation for finding, collecting and quantifying content quality from multiple centralized creator websites and software applications; Tokenization for converting content quality into a standard token that can be held, transferred and converted into other tokens on a decentralized blockchain; and Dispersion for sending tokenized Likes to wallet of creators.

The following description and drawings detail the invention in further and in various embodiments.

### BRIEF DESCRIPTION OF THE DRAWINGS

FIG. 1 shows an illustrative diagram of the user interface (UI) on a portable electronic device used by creators, utilizing the computer implemented tokenization system.

FIG. 2 shows an illustrative diagram of Excavation for finding, collecting, and quantifying content quality from multiple centralized websites and software applications.

FIG. 3 shows an illustrative diagram of Tokenization for converting content quality into a standard token and transferring them on a decentralized blockchain.

FIG. 4 shows an illustrative diagram of Dispersion for sending tokenized likes to creators' wallets.

### DETAILED DESCRIPTION

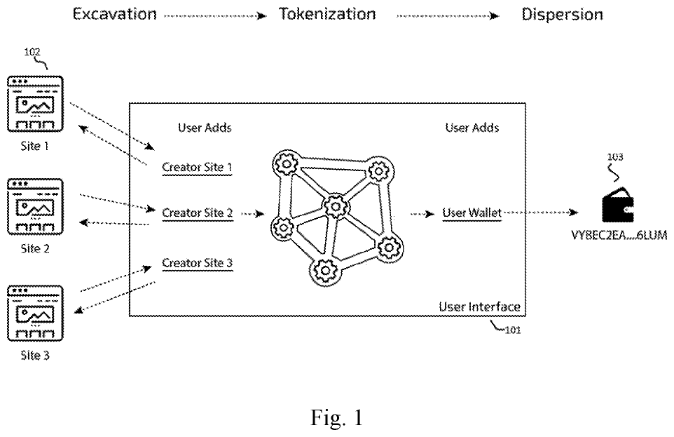

FIG. 1 provides an illustrative diagram of a UI 101 which allows creators to add and connect their accounts to their blockchain wallet 103. The UI may be a website UI accessed via a portable electronic device. The UI 101 utilizes the computer-implemented tokenization system, which allows the creator to excavate, tokenize, disperse, and retain custody of content quality. The content quality is excavated from different websites and software applications 102 in different forms which is then tokenized in a standardized token; and dispersed to creator's designated blockchain wallet 103. A blockchain wallet 103 is a digital wallet allows creators to store, manage, and trade standardized tokens.

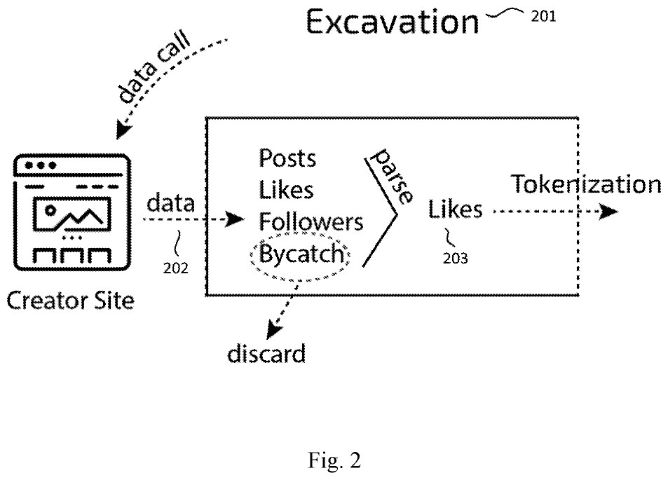

FIG. 2 shows an illustrative diagram of the Excavation 201 to excavate creators likes by finding, aggregating, and quantifying the likes from the respective websites and software applications 102. This could be done manually by counting the number of hearts, thumbs up, upvotes and followers a creator has on all its posts on all the websites and software applications 102. The said process, however, may be automated with use of the computer-implemented tokenization system. The computer-implemented tokenization system enables authorization from websites and software applications like Reddit®, TikTok®, Instagram®, Facebook® and YouTube® to connect to their Application Programming Interfaces (API). These APIs frequently provide the engagement data 202 needed. Once connected, API calls are made by the computer-implemented tokenization system to excavate and parse data such as likes. The computer implemented tokenization system may be configured to retain the essential likes 203 and discard any unwanted data. Once done, the required data is acquired and sent for tokenization.

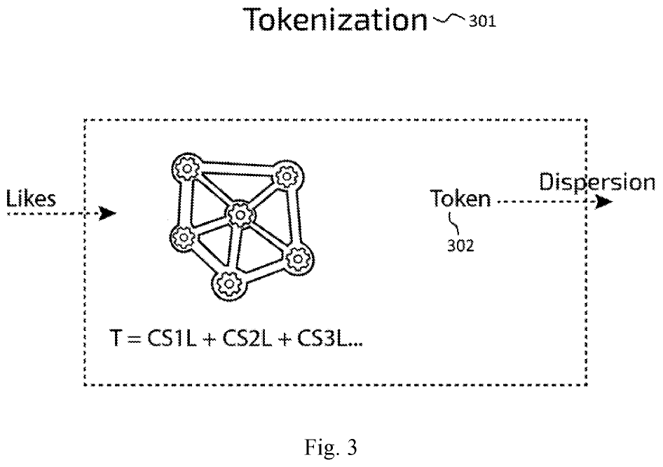

FIG. 3 shows an illustrative diagram of Tokenization 301 for converting content quality (likes) 203 into a token 302 that can be held, transferred, and converted into other assets on a decentralized blockchain. The first step in the Tokenization process involves aggregating the likes from each of the Creator's website/application.

$$T = CS 1 L + C S 2 L + CS3L …$$

Where:
T=Number of tokens
CSIL=Number of Likes on Creator Website 1
CS2L=Number of Likes on Creator Website 2
CS3L=Number of Likes on Creator Website 3 . . . .

Conceptually, the computer-implemented tokenization system sums all the likes creators gets on all the websites and software applications being used by creators and converts them into tokens. Several presets, however, may be set, depending on what outcome the manager of the computer implemented tokenization system wants to achieve. A manager, for example, can programmatically determine if one like equals one token, if a like on one site has the same value as a like on another, which token to convert the likes to, how many tokens to use, which blockchain to use, and how often to tokenize likes. Defining these settings standardizes the data so it can be compared, integrated and tokenized. The parity and weights of these metrics can also be adjusted by the managers of the computer implemented tokenization system over time depending on the use and settings.

By way of example, and not limitation, the computer implemented tokenization system could convert likes into an Algorand Standard Asset (ASA) on the Algorand blockchain, like VYBE. VYBE is an ASA token minted on the Algorand blockchain that consists of 10 billion equal parts. Each part, or token, can be privately held, transferred and converted into other assets. As such, the entity using the computer implemented tokenization system could excavate likes off creators' sites, quantify and convert them into VYBE, and disperse them to creators' wallets as a standardized measure of content quality.

The tokenization entity could use a fixed pool of VYBE to do this. If, for example, they could used 6.5 billion VYBE to tokenize likes and distribute them to creators every day for 20 years, then they would distribute 890,411 VYBE to creators every day. They could use the following basic formula, or a customized derivative of it, to determine how many VYBE to distribute to creators every day:

$$vd = ( ccq / tcq ) * 890 , 411$$

where:
vd=VYBE dispersed. The amount of VYBE dispersed to a user that day.
ccq=Creator Content Quality. The total number of likes, posts, comments, retweets, subscribers, hashtags and other engagement a creator gets for their content on their creator websites and software applications that day.
tcq=Total Content Quality. The total number of all likes, posts, comments, retweets, subscribers, hashtags, and other engagement that all creators get on all websites and software applications that day.

By way of the present example, the computer-implemented tokenization system would take the total number of likes of each creator, divide this by the total number of likes all creators got that day, and multiply this proportion by 890,411 to calculate how many likes each creator tokenized and how many corresponding VYBE were mined by them. The computer implemented tokenization system may automatically deposit this amount in each creator's Algorand wallet and repeat this tokenization cycle every 24 hours. In this example, creators are thus miners who mine by posting on creator websites and software applications and competing against each other for a proportional percentage of the fixed daily pool.

This is just one version of the computer implemented tokenization system. As noted, the manager of the computer-implemented tokenization system may make several modifications from this base formula. They could, for example, include posts as a form of engagement, and weigh this less than the number of likes, or cap creator's gains to deter mining attacks.

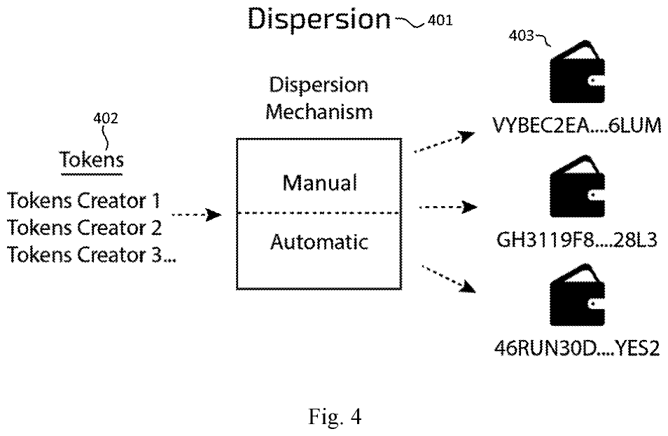

FIG. 4 shows an illustrative diagram of Dispersion 401 for sending tokenized Likes 402 to wallet of creators 403. Once the computer-implemented tokenization system has excavated and tokenized likes, the computer-implemented tokenization system disperses the tokenized likes to the creators by sending them to their blockchain wallets. This can be done manually or automatically.

Using this invention, a creator's content quality can be excavated from their centralized creator websites and software applications, tokenized, and moved to their private wallet on a decentralized blockchain, where it can be held, sent or converted into other assets. The computer-implemented tokenization system makes it possible to convert content quality into tokens that can be used on decentralized blockchain.

Various exemplary embodiments of the present system are disclosed. In one exemplary embodiment, implemented is a computer-implemented tokenization system configured to perform excavation; tokenization; and dispersion, comprising: one or more processors; one or more hardware-based memory devices storing executable instructions which, when executed by the one or more processors, causing the computer-implemented tokenization system to perform Excavation for finding, collecting and quantifying content quality from multiple centralized creator websites and software applications, Tokenization for converting content quality into a standard token that can be held, transferred and converted into other tokens on a decentralized blockchain, and Dispersion for sending tokenized Likes to wallet of creators.

In another exemplary embodiment, implemented is a method executed by a computer-implemented tokenization system, comprising: Excavation for finding, collecting and quantifying content quality from multiple centralized creator websites and software applications, Tokenization for converting content quality into a standard token that can be held, transferred and converted into other tokens on a decentralized blockchain, and Dispersion for sending tokenized likes to wallet of creators.

In another exemplary embodiment, implemented is one or more hardware-based non-transitory computer-readable memory devices having instructions which, when executed by one or more processors disposed in a computer-implemented tokenization system, cause the a computer-implemented tokenization system to: perform Excavation for finding, collecting and quantifying content quality from multiple centralized creator websites and software applications; Tokenization for converting content quality into a standard token that can be held, transferred and converted into other tokens on a decentralized blockchain; and Dispersion for sending tokenized Likes to wallet of creators.

What is claimed:

1. A computer-implemented tokenization system, comprising:
one or more processors;
one or more hardware-based memory devices storing executable instructions which, when executed by the one or more processors, cause the computer-implemented tokenization system to perform:
Excavation for finding, collecting, and quantifying content quality associated with creator account from multiple centralized websites and software applications, and
Tokenization for converting content quality into a standard token that can be held, transferred, and converted into other assets on a decentralized blockchain, and
Dispersion for sending tokenized Likes to wallet of creator.

2. The computer-implemented tokenization system of claim 1, wherein likes includes any one or more forms of engagement to measure content quality, comprising of hearts, thumbs up, upvotes, comments, retweets, followers, and subscribers.

3. The computer-implemented tokenization system of claim 1, wherein the Excavation includes authorization from content aggregation platforms by connecting their Application Programming Interfaces (API) to the computer-implemented tokenization system for excavating and parsing the likes.

4. The computer-implemented tokenization system of claim 1, wherein the Tokenization includes aggregation of all the excavated likes a creator gets on all their websites and software applications and converting these likes into tokens.

5. The computer-implemented tokenization system of claim 1, wherein the Tokenization includes converting likes into an Algorand Standard Asset (ASA) being VYBE on the Algorand blockchain.

6. The computer-implemented tokenization system of claim 1, wherein the Tokenization includes adjusting the parity and weights of presets depending on what outcome the manager of the computer implemented tokenization system wants to achieve.

7. The computer-implemented tokenization system of claim 1, wherein the Dispersion includes transfer of tokenized likes into wallets.

8. A method executed by the computer-implemented tokenization system, comprising:
Excavation for finding, collecting and quantifying content quality associated with creator account from multiple centralized websites and software applications, and
Tokenization for converting content quality into a standard token that can be held, transferred and converted into assets on a decentralized blockchain, and
Dispersion for sending tokenized likes to wallet of creator.

9. The method executed by the computer-implemented tokenization system of claim 8, wherein the likes include any one or more forms of engagement comprising hearts, thumbs up, upvotes, comments, retweets, followers, and subscribers.

10. The method executed by the computer-implemented tokenization system of claim 8, wherein the Excavation includes authorization from content aggregation platforms by connecting their Application Programming Interfaces (API) to the computer-implemented tokenization system for excavating and parsing the Likes.

11. The method executed by the computer-implemented tokenization system of claim 8, wherein the Tokenization includes aggregation of all the excavated Likes a creator gets on all their websites and software applications and conversion of likes into tokens.

12. The method executed by the computer-implemented tokenization system of claim 8, wherein the Tokenization includes converting likes into an Algorand Standard Asset (ASA) being VYBE on the Algorand blockchain.

12. The method executed by the computer-implemented tokenization system of claim 8, wherein the Tokenization includes adjusting the parity and weights of presets depending on what outcome the manager of the computer implemented tokenization system wants to achieve.

14. The method executed by the computer-implemented tokenization system of claim 8, wherein the Dispersion includes transfer of tokenized likes into wallets.

15. One or more hardware-based non-transitory computer-readable memory devices having instructions which, when executed by one or more processors disposed in the computer-implemented tokenization system, cause the computer-implemented tokenization system to perform:
Excavation for finding, collecting, and quantifying content quality associated with creator account from multiple centralized creator websites and software applications, and
Tokenization for converting content quality into a standard token that can be held, transferred and converted into other assets on a decentralized blockchain, and
Dispersion for sending tokenized Likes to wallet of creator.
